(19) United States
(12) Patent Application Publication
(10) Pub. No.: US 2010/0034141 A1
(43) Pub. Date: Feb. 11, 2010

(54) METHOD AND APPARATUS FOR INITIATING RANDOM ACCESS PROCEDURE IN WIRELESS NETWORKS

(75) Inventor: Arnaud Meylan, Bois-Colombes (FR)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/500,548

(22) Filed: Jul. 9, 2009

Related U.S. Application Data
(60) Provisional application No. 61/086,735, filed on Aug. 6, 2008.

(51) Int. Cl. H04W 74/04

(52) U.S. Cl. 370/328

(57) ABSTRACT

A method for wireless communications is provided. The method includes receiving measurement gap information and receiving random access procedure information. The method also includes scheduling a random access procedure based on the measurement gap information and the random access procedure information. By scheduling random access procedures in view of the measurement gap information, network bandwidth can be conserved.

### CLAIM OF PRIORITY UNDER 35 U.S.C. §119

This application claims the benefit of U.S. Provisional Patent Application No. 61/086,735, entitled METHOD AND APPARATUS FOR INITIATING RANDOM ACCESS PROCEDURE IN WIRELESS NETWORKS, and filed on Aug. 6, 2008, the entirety of which is incorporated herein by reference.

### BACKGROUND

I. Field

The following description relates generally to wireless communications systems, and more particularly to scheduling of random access control channel transmissions.

II. Background

Wireless communication systems are widely deployed to provide various types of communication content such as voice, data, and so forth. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems including E-UTRA, and orthogonal frequency division multiple access (OFDMA) systems.

An orthogonal frequency division multiplex (OFDM) communication system effectively partitions the overall system bandwidth into multiple (N_{F}) subcarriers, which may also be referred to as frequency sub-channels, tones, or frequency bins. For an OFDM system, the data to be transmitted (i.e., the information bits) is first encoded with a particular coding scheme to generate coded bits, and the coded bits are further grouped into multi-bit symbols that are then mapped to modulation symbols. Each modulation symbol corresponds to a point in a signal constellation defined by a particular modulation scheme (e.g., M-PSK or M-QAM) used for data transmission. At each time interval that may be dependent on the bandwidth of each frequency subcarrier, a modulation symbol may be transmitted on each of the N_{F} frequency subcarrier. Thus, OFDM may be used to combat inter-symbol interference (ISI) caused by frequency selective fading, which is characterized by different amounts of attenuation across the system bandwidth.

Generally, a wireless multiple-access communication system can concurrently support communication for multiple wireless terminals that communicate with one or more base stations via transmissions on forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

A MIMO system employs multiple (NT) transmit antennas and multiple (NR) receive antennas for data transmission. A MIMO channel formed by the NT transmit and NR receive antennas may be decomposed into NS independent channels, which are also referred to as spatial channels, where N_{S}≦min{N_{T}, N_{R}}. Generally, each of the NS independent channels corresponds to a dimension. The MIMO system can provide improved performance (e.g., higher throughput and/or greater reliability) if the additional dimensionalities created by the multiple transmit and receive antennas are utilized. A MIMO system also supports time division duplex (TDD) and frequency division duplex (FDD) systems. In a TDD system, the forward and reverse link transmissions are on the same frequency region so that the reciprocity principle allows estimation of the forward link channel from the reverse link channel. This enables an access point to extract transmit beam-forming gain on the forward link when multiple antennas are available at the access point.

Related to such wireless systems includes monitoring other networks or channels while the receiver is active since different frequencies may be involved, where the wireless device can generally only receive on one channel at a time. Thus, the device listens to other frequencies to determine if a more suitable base station (eNodeB or eNB) is available. In the active state, the eNB provides measurement gaps in the scheduling of the user equipment (UE) where no downlink or uplink scheduling occurs. Ultimately, the network makes the decision, but the gap provides the UE sufficient time to change frequency, perform a measurement, and switch back to the active channel. When measurement gaps are scheduled, the UE may have a conflict between the need to stay on the source frequency to complete a random access channel (RACH) procedure or switch on to the target frequency to perform the measurement. If the UE switches on to the target frequency, the eNB may send a random access response or schedule a transmission during the measurement gap causing network bandwidth to be wasted.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

Systems and methods are provided to schedule random access channel (RACH) procedures such that network bandwidth is conserved. In an aspect, user equipment (UE) initiates a RACH procedure when it can ensure that RACH messages associated with the procedure such as random access preambles, random access responses, or other scheduled transmissions for example are transmitted before the occurrence of the next measurement gap. Thus, scheduling components are provided to determine the occurrence of the respective measurements gaps and to schedule the RACH (or PRACH for physical channel) messages between the gaps. By transmitting the RACH messages or procedure between the measurement gaps, network bandwidth is more efficiently utilized.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a high level block diagram of a system that employs random access procedure scheduling in a wireless communications environment.

FIG. 2 is a diagram that illustrates an example random access procedure.

FIG. 3 is a timing diagram illustrates example PRACH transmissions to conserve network bandwidth.

FIG. 4 illustrates example timing for RACH and AICH messages.

FIG. 5 illustrates a wireless communications method for random access procedure scheduling.

FIG. 6 illustrates an example logical module for a wireless protocol.

FIG. 7 illustrates an example logical module for an alternative wireless protocol.

FIG. 8 illustrates an example communications apparatus that employs a wireless protocol.

FIG. 9 illustrates a multiple access wireless communication system.

FIGS. 10 and 11 illustrate example communications systems.

### DETAILED DESCRIPTION

Systems and methods are provided to schedule random access procedures in order to conserve network bandwidth. In one aspect, a method for wireless communications is provided. The method includes employing a processor executing computer executable instructions stored on a computer readable storage medium to implement various acts or processes. This includes receiving measurement gap information and receiving random access procedure information. The method also includes scheduling a random access procedure based on the measurement gap information and the random access procedure information.

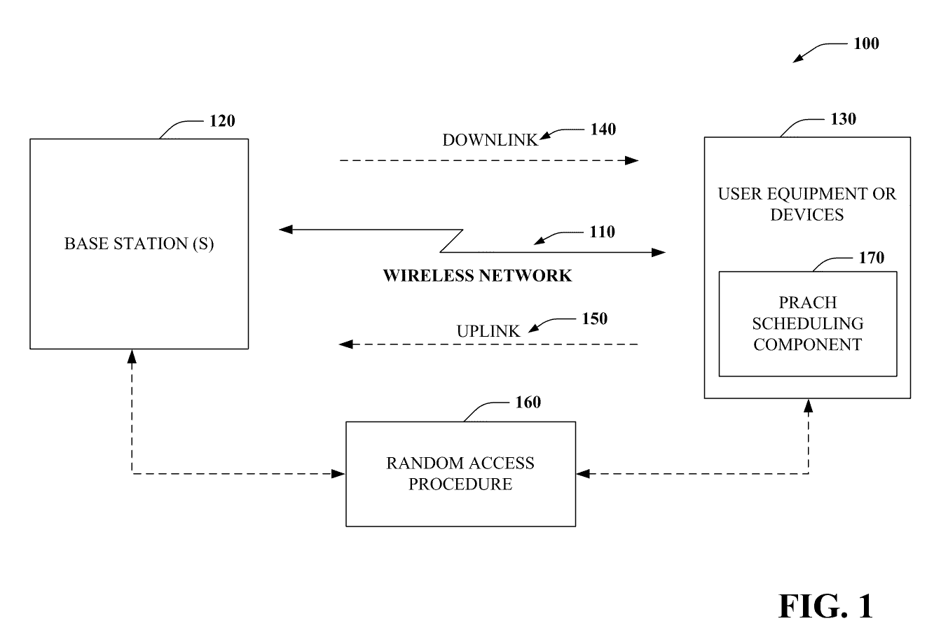

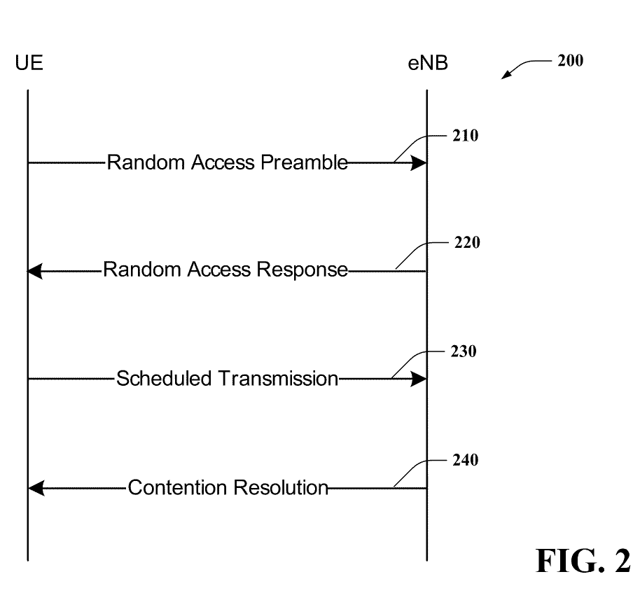

Referring now to FIG. 1, random access procedures are dynamically scheduled for a wireless communications system. The system 100 includes one or more base stations 120 (also referred to as a node, evolved node B—eNB, femto station, pico station, and so forth) which can be an entity capable of communication over a wireless network 110 to a second device 130 (or devices). For instance, each device 130 can be an access terminal (also referred to as terminal, user equipment, mobility management entity (MME) or mobile device). The base station 120 communicates to the device 130 via downlink 140 and receives data via uplink 150. Such designation as uplink and downlink is arbitrary as the device 130 can also transmit data via downlink and receive data via uplink channels. It is noted that although two components 120 and 130 are shown, that more than two components can be employed on the network 110, where such additional components can also be adapted for the wireless protocols or procedures described herein. As shown, a random access procedure is exchanged between the base station 120 and the terminal 130. The random access procedure 160 which is described in more detail below with respect to FIG. 2 is scheduled via a physical random access channel (PRACH) scheduling component 170, where the scheduling component is employed to schedule random access procedure messages within measurement gaps, where the gaps provide the UE sufficient time to change frequencies, perform a network measurement, and switch back to the active channel, for example. Although only one scheduling component 170 is shown on the terminal 130, it is to be appreciated that other scheduling components can be employed across the network 110 and/or at the base station 120.

In general, the system 100 schedules random access channel (RACH) procedures 160 such that network bandwidth is conserved. The user equipment (UE) 130 initiates a RACH procedure 160 when it can ensure (or facilitate) that RACH messages associated with the procedure such as random access preambles, random access responses, or other scheduled transmissions for example are transmitted before the occurrence of the next measurement gap. Thus, scheduling components 170 are provided to determine the occurrence of the respective measurements gaps and to schedule the RACH (or PRACH for physical channel) messages between the gaps. By transmitting the RACH messages or procedure 160 between the measurement gaps, network bandwidth is more efficiently utilized.

In another aspect, various wireless processing methods can be employed in the system 100. This includes receiving measurement gap information and receiving random access procedure information. Upon receiving such information, the scheduling component 170 directs a random access procedure 160 based on the measurement gap information and the random access procedure information. This includes scheduling the random access procedure between the measurement gaps. In other words, determining that one or more components of the random access procedure 160 do not overlap the measurement gaps.

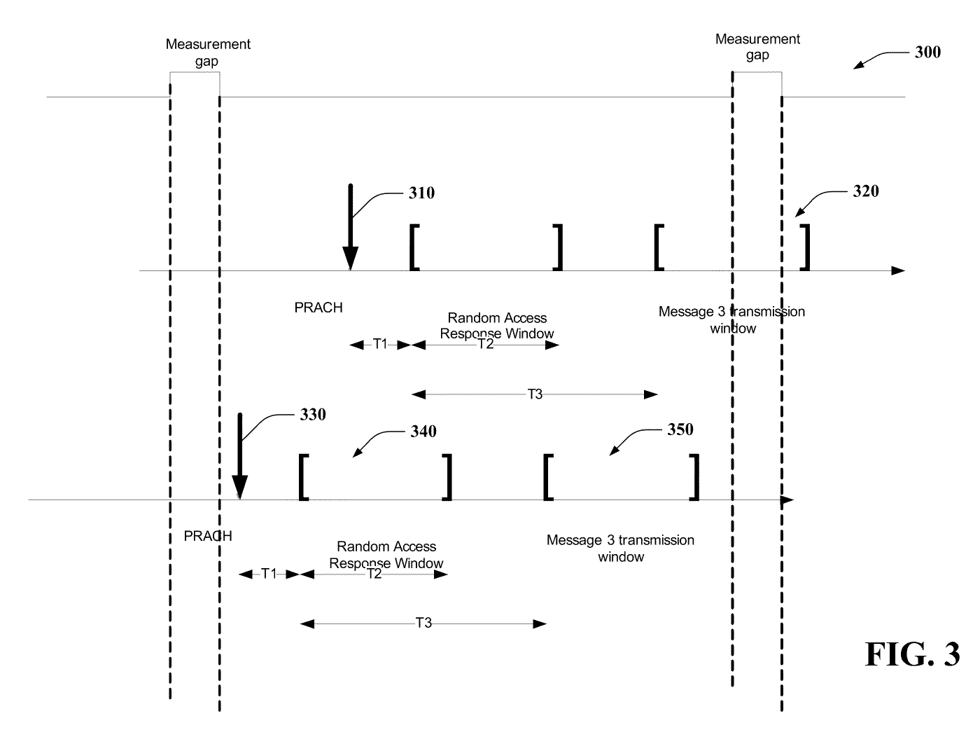

As will be described in more detail below, the random access procedure can include at least one random access preamble, at least one random access response, at least one scheduled message transmission, and/a portion of a transmission for contention resolution. The random access procedure can be associated with a random access channel (RACH) that is transmitted across a physical random access channel (PRACH), for example. As will be described in more detail below with respect to FIG. 3, a first time period may be defined by the scheduler that enables the beginning of the PRACH. This can include defining a second time period that begins about at the end of the first time period and provides a random access response window, for example. A third time period begins about at the first time period, extends past the second time period, and ends about at a scheduled transmission window. The scheduling component 170 determines a timing displacement for one or more measurement gaps and schedules a PRACH transmission when a random access response window and a scheduled transmission window (or other random access procure components) do not overlap with the one or more measurement gaps.

Before proceeding, some discussion or RACH is provided. The RACH is a common transport channel in the uplink and is generally mapped one-to-one onto physical channels (PRACHs). In one cell, several RACHs/PRACHs may be configured. If more than one PRACH is configured in a cell, the UE performs PRACH selection randomly. Parameters for RACH access procedure includes: access slots, preamble scrambling code, preamble signatures, spreading factor for data part, available signatures and sub-channels for each Access Service Class (ASC) and power control information. The Physical channel information for PRACH can be broadcast in SIB5/6 and the fast changing cell parameters such as uplink interference levels used for open loop power control and dynamic persistence value can be broadcast in SIB7, for example.

The RACH access procedure 160 generally follows slotted-ALOHA approach with fast acquisition indication combined with power ramping in steps. Typically, 16 different PRACHs can be offered in a cell, in FDD, the various PRACHs can be distinguished either by employing different preamble scrambling codes or by using common scrambling code with different signatures and sub-channels. Within a single PRACH, a partitioning of the resources between the eight ASC is possible, thereby providing a means of access prioritization between ASCs by allocating more resources to high priority classes than to low priority classes. Generally, ASC 0 is assigned highest priority and ASC 7 is assigned lowest priority. Thus, ASC 0 can be used to perform emergency calls that have more priority. The available 15 access slots can be split between 12 RACH sub-channels, for example.

The RACH transmission includes at least two parts, namely preamble transmission and message part transmission. The preamble part is 4096 chips, transmitted with spreading factor 256 and uses one of 16 access signatures and fits into one access slot. The ASC is defined by an identifier i that defines a certain partition of the PRACH resources and is associated with persistence value P(i). The persistence value for P(0) is generally set to one and is associated with ASC 0. The persistence values for others are calculated from signaling. These persistence values controls the RACH transmissions.

To start a RACH procedure, the UE selects a random number r, between 0 and 1 and if r<=P(i), the physical layer PRACH procedure is initiated else it is deferred by 10 ms and then the procedure is started again. When the UE PRACH procedure is initiated, then the real transmission occurs. As described above, the preamble part transmission starts first. The UE selects one access signature of those available for the given ASC and an initial preamble power level based on the received primary CPICH power level and transmits by selecting randomly one slot out of the next set of access slots belonging to one of the PRACH sub-channels associated with the relevant ASC.

The UE then waits for the appropriate access indicator sent by the network on the downlink Acquisition Indicator Channel (AICH) access slot which is paired with the uplink access slot on which the preamble was sent. There are typically three possible scenarios:

If the Acquisition Indication (AI) received is a positive acknowledgement, then UE sends the data after a predefined amount of with a power level which is calculated from the level used to send the last preamble.

IF the AI received is a negative acknowledgement, the UE stops with the transmission and hands back control to the MAC layer. After a back-off period, the UE can regain access according to the MAC procedure based on persistence probabilities.

If no acknowledgement is received, then it is considered that network did not receive the preamble. If the maximum number of preambles that can be sent during a physical layer PRACH procedure is not exceeded, the terminal 130 sends another preamble by increasing the power in steps. The ability of the UE 130 to increase its output power, in terms of steps to a specific value is referred to as open loop power control, where RACH generally follows open loop power control.

It is noted that the system 100 can be employed with an access terminal or mobile device, and can be, for instance, a module such as an SD card, a network card, a wireless network card, a computer (including laptops, desktops, personal digital assistants (PDAs)), mobile phones, smart phones, or any other suitable terminal that can be utilized to access a network. The terminal accesses the network by way of an access component (not shown). In one example, a connection between the terminal and the access components may be wireless in nature, in which access components may be the base station and the mobile device is a wireless terminal. For instance, the terminal and base stations may communicate by way of any suitable wireless protocol, including but not limited to Time Divisional Multiple Access (TDMA), Code Division Multiple Access (CDMA), Frequency Division Multiple Access (FDMA), Orthogonal Frequency Division Multiplexing (OFDM), FLASH OFDM, Orthogonal Frequency Division Multiple Access (OFDMA), or any other suitable protocol.

Access components can be an access node associated with a wired network or a wireless network. To that end, access components can be, for instance, a router, a switch, or the like. The access component can include one or more interfaces, e.g., communication modules, for communicating with other network nodes. Additionally, the access component can be a base station (or wireless access point) in a cellular type network, wherein base stations (or wireless access points) are utilized to provide wireless coverage areas to a plurality of subscribers. Such base stations (or wireless access points) can be arranged to provide contiguous areas of coverage to one or more cellular phones and/or other wireless terminals.

Referring now to FIG. 2, a diagram 200 illustrates an example random access procedure for a wireless system. It is noted that although four components or messages are shown with the example procedure 200, that other components or messages are also possible. As shown, the procedure 200 may include a random access preamble 210, a random access response 220, scheduled transmissions 230, and/or contention resolution portions 240. When measurement gaps are scheduled as shown below in FIG. 3, the UE may have a conflict between the need to stay on the source frequency to complete the RACH procedure or direct toward target frequency to perform the measurement. If the UE switches on target frequency, the eNB may send the message 220 or schedule message 230 during the measurement gap and network bandwidth could be wasted in that scenario. Instead, the UE initiated a RACH procedure 200 when it can enable a message 210, 220 and/or 230, for example, that can be transmitted before the occurrence of the next measurement gap as illustrated below in FIG. 3.

Turning to FIG. 3, a timing diagram 300 illustrates example PRACH transmissions to conserve network bandwidth. At 310, a faulty scheduling sequence begins where a scheduled transmission overlaps a measurement gap at 320. The faulty sequence should be disallowed by configuration of the respective scheduling component. According to one aspect, the PRACH should begin at 330 where timing or scheduling periods T1, T2, and T3 are defined. In general, when measurement gaps are configured, proceed with a PRACH transmission only if neither the random access window at 340, nor the scheduled transmission window 350 overlaps (or other configured message) with a measurement gap. In general, PRACH is transmitted according to the following periods:
After T1, the random access response window starts;
The random access window has a width of T2; and
A scheduled message transmission in response to a random access response received in the window can occur during a “scheduled message transmission window” which starts T1+T3 after PRACH, where T3 is the time between reception of a uplink (UL) grant in a random access response message and the corresponding transmission on UL-SCH. Periods T1, T2, and T3 can be specified in readily available standards for RACH and PRACH.

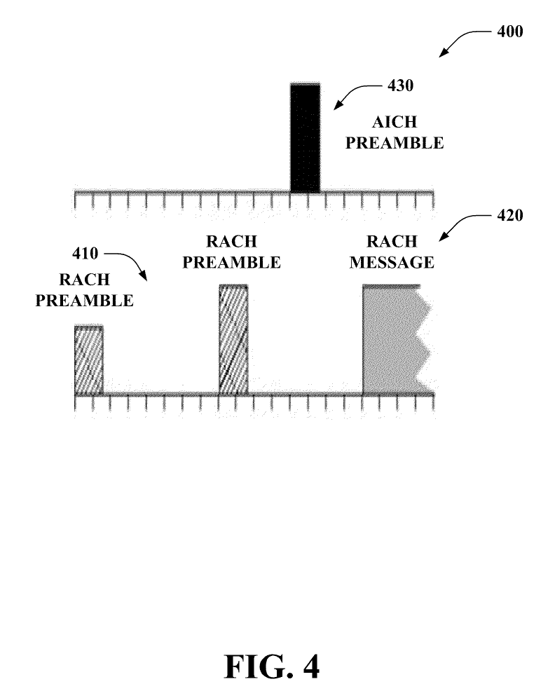

Referring to FIG. 4, a diagram 400 illustrates timing aspects of a random access control channel. The RACH procedure is illustrated in the diagram 400, where the terminal transmits the preamble until acknowledgement is received on AICH (acquisition indicator channel), and then the message part follows. In the case of data transmission on RACH, the spreading factor and thus the data rate may vary. Spreading factors from 256 to 32 have been defined to be possible, thus a single frame on RACH may contain up to 1200 channel symbols which, depending on the channel coding, maps to around 600 or 400 bits. For the maximum number of bits the achievable range is naturally less than what can be achieved with the lowest rates, especially as RACH messages do not use methods such as macro-diversity as in the dedicated channel. As shown, RACH preamble messages are illustrated at 410, where an RACH message is illustrated at 420. An AICH preamble message is shown at 430.

The Random Access Channel is considered an uplink transport channel. The RACH is generally received from the entire cell. The RACH is characterized by a collision risk and by being transmitted using open loop power control. The Random Access Channel is typically used for signaling purposes, to register the terminal after power-on to the network or to perform location update after moving from one location area to another or to initiate a call. The structure of the physical RACH for signaling purposes is generally the same as when using the RACH for user data transmission.

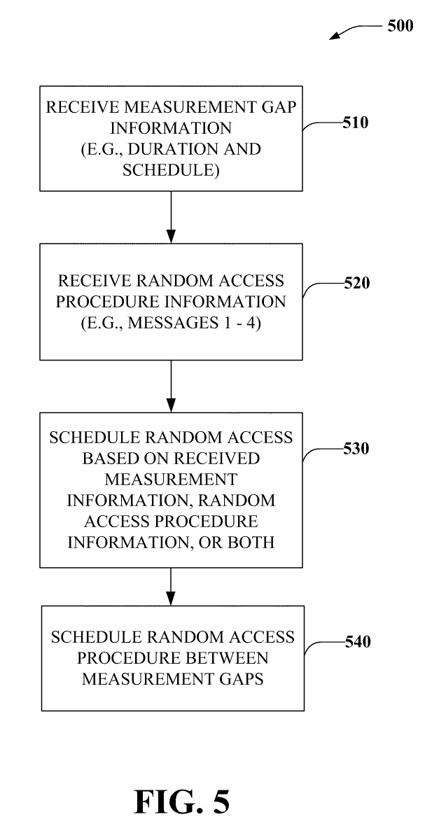

Referring now to FIG. 5, a wireless communications methodology 500 is illustrated. While, for purposes of simplicity of explanation, the methodology (and other methodologies described herein) are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be utilized to implement a methodology in accordance with the claimed subject matter.

Proceeding to 510, measurement gap information is received. The measurement gap information can include the duration of the measurement gap and also when the gaps are scheduled to occur (e.g., time when the measurement gaps occur in the future). At 520, information about the random access procedure (also referred to herein as random access procedure information or RAP information) is received. In one example, the random access procedure information includes, but is not limited to, information about message 1 (random access preamble), message 2 (random access response), message 3 (scheduled message transmission), and/or message 4 (contention resolution). This information can include the time when a particular message window begins, the time when a particular message window ends, the duration of such a message window, when the particular message is scheduled to be received, when the particular message is scheduled to be transmitted, and so forth. At 530, based on the measurement gap information and the random access procedure information, a random access procedure is scheduled. For example, in one aspect, the UE proceeds or initiates a random access procedure only when one or more message windows of the random access procedure do not overlap with a measurement gap as shown at 540.

The techniques described herein may be implemented by various means. For example, these techniques may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. With software, implementation can be through modules (e.g., procedures, functions, and so on) that perform the functions described herein. The software codes may be stored in memory unit and executed by the processors.

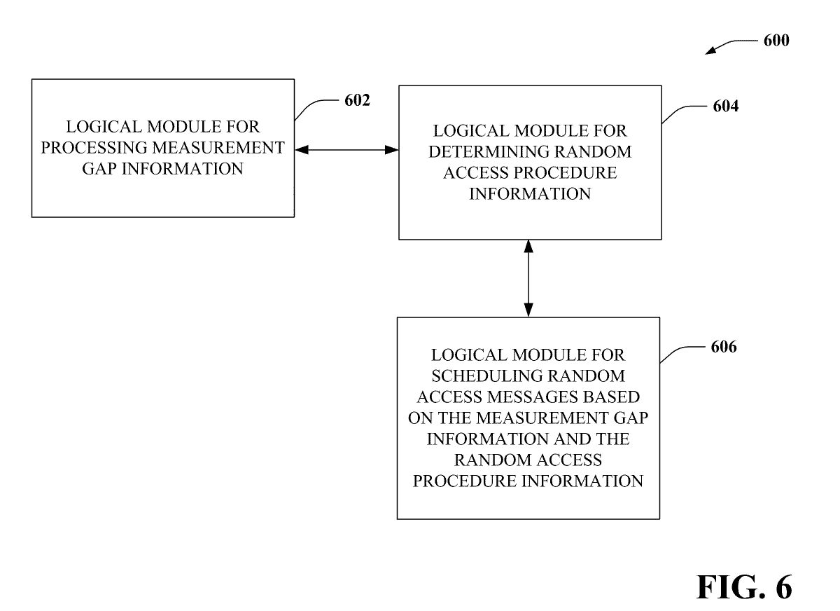

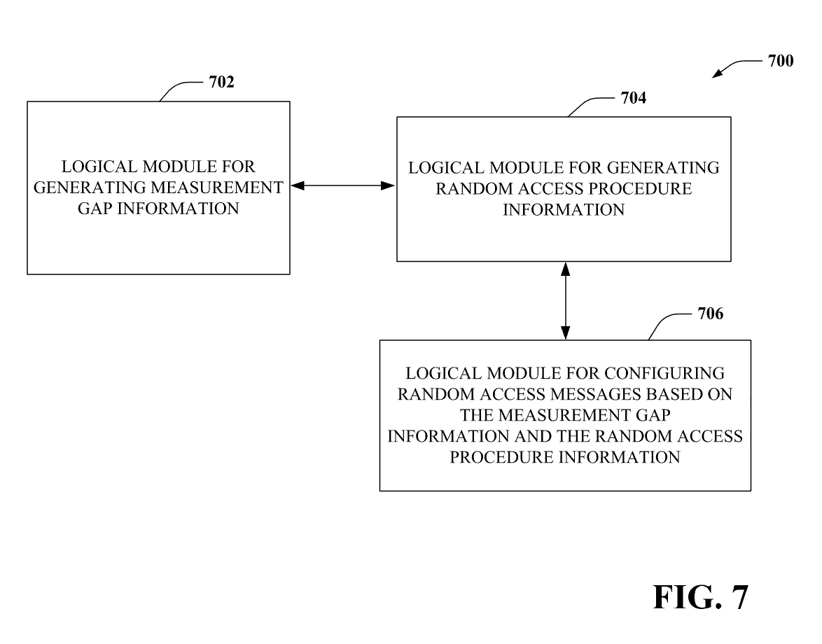

Turning now to FIGS. 6 and 7, a system is provided that relates to wireless signal processing. The systems are represented as a series of interrelated functional blocks, which can represent functions implemented by a processor, software, hardware, firmware, or any suitable combination thereof.

Referring to FIG. 6, a wireless communication system 600 is provided. The system 600 includes a logical module 602 for processing measurement gap information and a logical module 604 for determining random access procedure information. The system 600 also includes a logical module 606 for scheduling random access messages based on the measurement gap information and the random access procedure information.

Referring to FIG. 7, a wireless communication system 700 is provided. The system 700 includes a logical module 702 for generating measurement gap information and a logical module 704 for generating random access procedure information. The system 700 also includes a logical module 706 for configuring random access messages based on the measurement gap information and the random access procedure information.

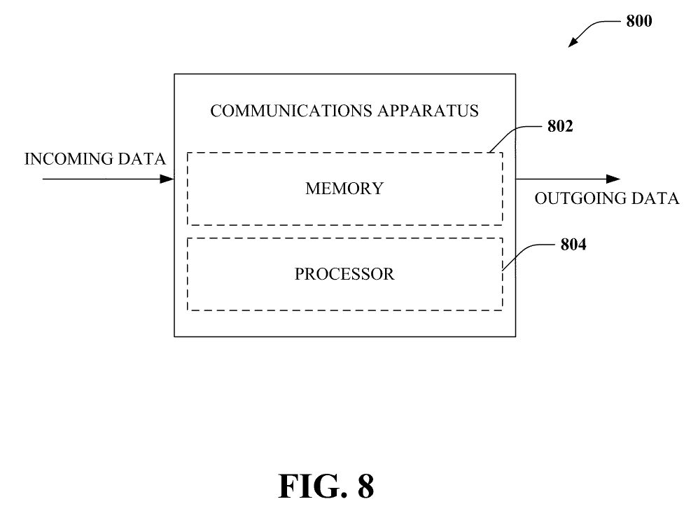

FIG. 8 illustrates a communications apparatus 800 that can be a wireless communications apparatus, for instance, such as a wireless terminal. Additionally or alternatively, communications apparatus 800 can be resident within a wired network. Communications apparatus 800 can include memory 802 that can retain instructions for performing a signal analysis in a wireless communications terminal. Additionally, communications apparatus 800 may include a processor 804 that can execute instructions within memory 802 and/or instructions received from another network device, wherein the instructions can relate to configuring or operating the communications apparatus 800 or a related communications apparatus.

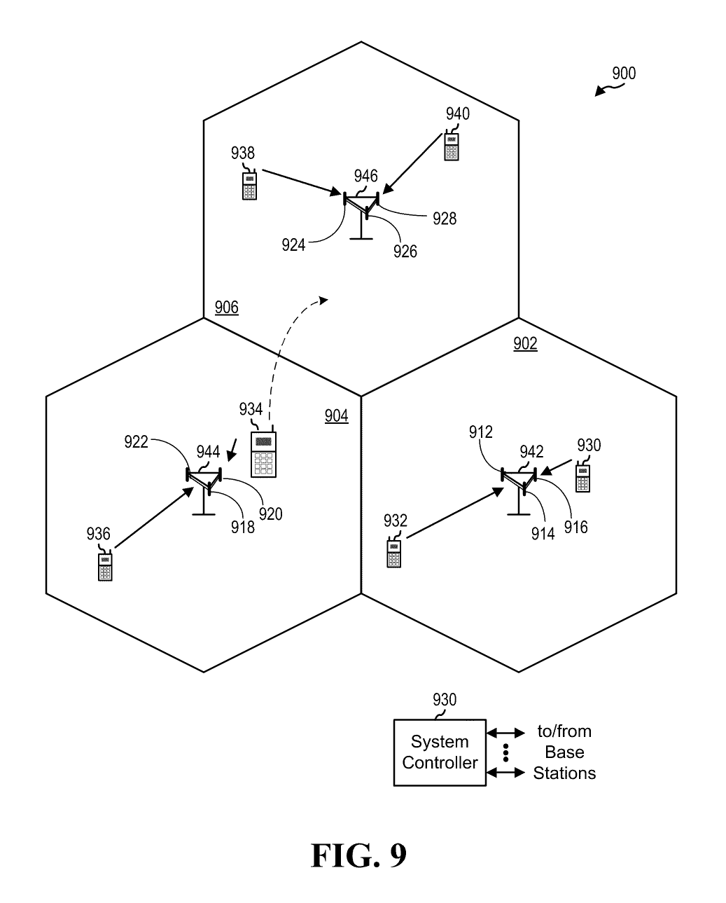

Referring to FIG. 9, a multiple access wireless communication system 900 is illustrated. The multiple access wireless communication system 900 includes multiple cells, including cells 902, 904, and 906. In the aspect the system 900, the cells 902, 904, and 906 may include a Node B that includes multiple sectors. The multiple sectors can be formed by groups of antennas with each antenna responsible for communication with UEs in a portion of the cell. For example, in cell 902, antenna groups 912, 914, and 916 may each correspond to a different sector. In cell 904, antenna groups 918, 920, and 922 each correspond to a different sector. In cell 906, antenna groups 924, 926, and 928 each correspond to a different sector. The cells 902, 904 and 906 can include several wireless communication devices, e.g., User Equipment or UEs, which can be in communication with one or more sectors of each cell 902, 904 or 906. For example, UEs 930 and 932 can be in communication with Node B 942, UEs 934 and 936 can be in communication with Node B 944, and UEs 938 and 940 can be in communication with Node B 946.

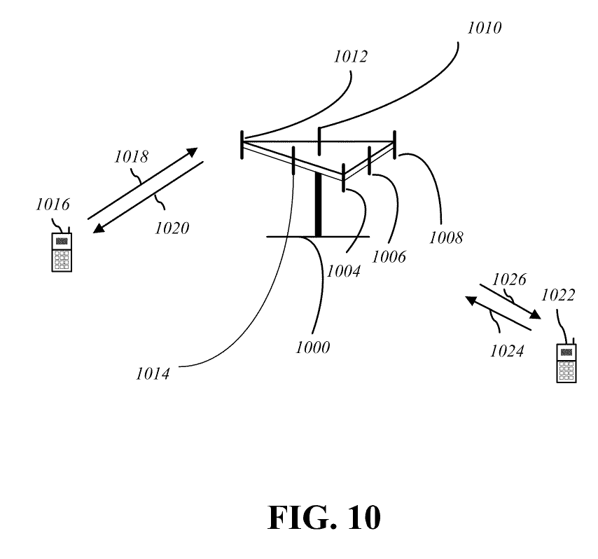

Referring now to FIG. 10, a multiple access wireless communication system according to one aspect is illustrated. An access point 1000 (AP) includes multiple antenna groups, one including 1004 and 1006, another including 1008 and 1010, and an additional including 1012 and 1014. In FIG. 10, only two antennas are shown for each antenna group, however, more or fewer antennas may be utilized for each antenna group. Access terminal 1016 (AT) is in communication with antennas 1012 and 1014, where antennas 1012 and 1014 transmit information to access terminal 1016 over forward link 1020 and receive information from access terminal 1016 over reverse link 1018. Access terminal 1022 is in communication with antennas 1006 and 1008, where antennas 1006 and 1008 transmit information to access terminal 1022 over forward link 1026 and receive information from access terminal 1022 over reverse link 1024. In a FDD system, communication links 1018, 1020, 1024 and 1026 may use different frequency for communication. For example, forward link 1020 may use a different frequency then that used by reverse link 1018.

Each group of antennas and/or the area in which they are designed to communicate is often referred to as a sector of the access point. Antenna groups each are designed to communicate to access terminals in a sector, of the areas covered by access point 1000. In communication over forward links 1020 and 1026, the transmitting antennas of access point 1000 utilize beam-forming in order to improve the signal-to-noise ratio of forward links for the different access terminals 1016 and 1024. Also, an access point using beam-forming to transmit to access terminals scattered randomly through its coverage causes less interference to access terminals in neighboring cells than an access point transmitting through a single antenna to all its access terminals. An access point may be a fixed station used for communicating with the terminals and may also be referred to as an access point, a Node B, or some other terminology. An access terminal may also be called an access terminal, user equipment (UE), a wireless communication device, terminal, access terminal or some other terminology.

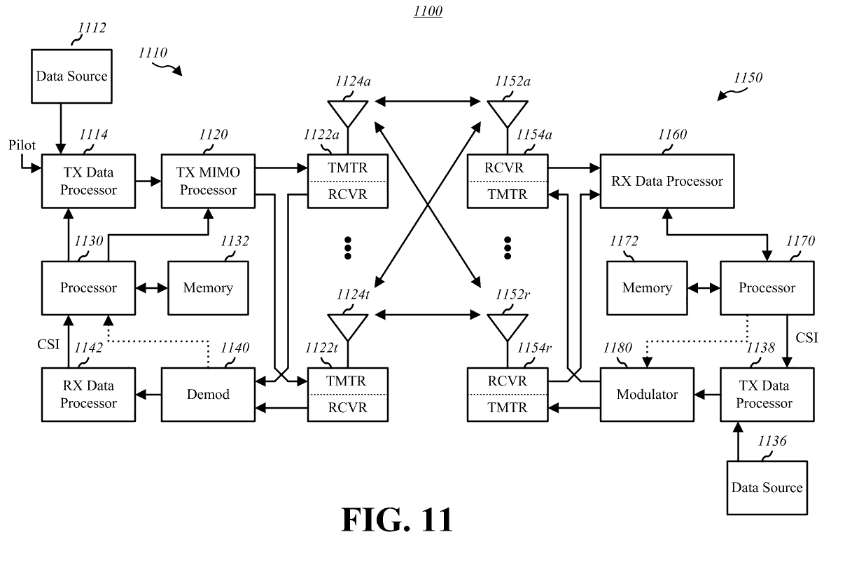

Referring to FIG. 11, a system 1100 illustrates a transmitter system 210 (also known as the access point) and a receiver system 1150 (also known as access terminal) in a MIMO system 1100. At the transmitter system 1110, traffic data for a number of data streams is provided from a data source 1112 to a transmit (TX) data processor 1114. Each data stream is transmitted over a respective transmit antenna. TX data processor 1114 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 1130.

The modulation symbols for all data streams are then provided to a TX MIMO processor 1120, which may further process the modulation symbols (e.g., for OFDM). TX MIMO processor 1120 then provides NT modulation symbol streams to NT transmitters (TMTR) 1122a through 1122t. In certain embodiments, TX MIMO processor 1120 applies beam-forming weights to the symbols of the data streams and to the antenna from which the symbol is being transmitted.

Each transmitter 1122 receives and processes a respective symbol stream to provide one or more analog signals, and further conditions (e.g., amplifies, filters, and up-converts) the analog signals to provide a modulated signal suitable for transmission over the MIMO channel. NT modulated signals from transmitters 1122a through 1122t are then transmitted from NT antennas 1124a through 1124t, respectively.

At receiver system 1150, the transmitted modulated signals are received by NR antennas 1152a through 1152r and the received signal from each antenna 1152 is provided to a respective receiver (RCVR) 1154a through 1154r. Each receiver 1154 conditions (e.g., filters, amplifies, and down-converts) a respective received signal, digitizes the conditioned signal to provide samples, and further processes the samples to provide a corresponding “received” symbol stream.

An RX data processor 1160 then receives and processes the NR received symbol streams from NR receivers 1154 based on a particular receiver processing technique to provide NT “detected” symbol streams. The RX data processor 1160 then demodulates, de-interleaves, and decodes each detected symbol stream to recover the traffic data for the data stream. The processing by RX data processor 1160 is complementary to that performed by TX MIMO processor 1120 and TX data processor 1114 at transmitter system 1110.

A processor 1170 periodically determines which pre-coding matrix to use (discussed below). Processor 1170 formulates a reverse link message comprising a matrix index portion and a rank value portion. The reverse link message may comprise various types of information regarding the communication link and/or the received data stream. The reverse link message is then processed by a TX data processor 1138, which also receives traffic data for a number of data streams from a data source 1136, modulated by a modulator 1180, conditioned by transmitters 1154a through 1154r, and transmitted back to transmitter system 1110.

At transmitter system 1110, the modulated signals from receiver system 1150 are received by antennas 1124, conditioned by receivers 1122, demodulated by a demodulator 1140, and processed by a RX data processor 1142 to extract the reserve link message transmitted by the receiver system 1150. Processor 1130 then determines which pre-coding matrix to use for determining the beam-forming weights then processes the extracted message.

In an aspect, logical channels are classified into Control Channels and Traffic Channels. Logical Control Channels comprises Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. Logical Traffic Channels comprise a Dedicated Traffic Channel (DTCH) which is Point-to-point bi-directional channel, dedicated to one UE, for the transfer of user information. Also, a Multicast Traffic Channel (MTCH) for Point-to-multipoint DL channel for transmitting traffic data.

Transport Channels are classified into DL and UL. DL Transport Channels comprises a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprises a Random Access Channel (RACH), a Request Channel (REQCH), an Uplink Shared Data Channel (UL-SDCH) and plurality of PHY channels. The PHY channels comprise a set of DL channels and UL channels.

The DL PHY channels comprises: Common Pilot Channel (CPICH), Synchronization Channel (SCH), Common Control Channel (CCCH), Shared DL Control Channel (SDCCH), Multicast Control Channel (MCCH), Shared UL Assignment Channel (SUACH), Acknowledgement Channel (ACKCH), DL Physical Shared Data Channel (DL-PSDCH), UL Power Control Channel (UPCCH), Paging Indicator Channel (PICH), and Load Indicator Channel (LICH), for example.

The UL PHY Channels comprises : Physical Random Access Channel (PRACH), Channel Quality Indicator Channel (CQICH), Acknowledgement Channel (ACKCH), Antenna Subset Indicator Channel (ASICH), Shared Request Channel (SREQCH), UL Physical Shared Data Channel (UL-PSDCH), and Broadband Pilot Channel (BPICH), for example.

Other terms/components include: 3G 3rd Generation, 3GPP 3rd Generation Partnership Project, ACLR Adjacent channel leakage ratio, ACPR Adjacent channel power ratio, ACS Adjacent channel selectivity, ADS Advanced Design System, AMC Adaptive modulation and coding, A-MPR Additional maximum power reduction, ARQ Automatic repeat request, BCCH Broadcast control channel, BTS Base transceiver station, CDD Cyclic delay diversity, CCDF Complementary cumulative distribution function, CDMA Code division multiple access, CFI Control format indicator, Co-MIMO Cooperative MIMO, CP Cyclic prefix, CPICH Common pilot channel, CPRI Common public radio interface, CQI Channel quality indicator, CRC Cyclic redundancy check, DCI Downlink control indicator, DFT Discrete Fourier transform, DFT-SOFDM Discrete Fourier transform spread OFDM, DL Downlink (base station to subscriber transmission), DL-SCH Downlink shared channel, D-PHY 500 Mbps physical layer, DSP Digital signal processing, DT Development toolset, DVSA Digital vector signal analysis, EDA Electronic design automation, E-DCH Enhanced dedicated channel, E-UTRAN Evolved UMTS terrestrial radio access network, eMBMS Evolved multimedia broadcast multicast service, eNB Evolved Node B, EPC Evolved packet core, EPRE Energy per resource element, ETSI European Telecommunications Standards Institute, E-UTRA Evolved UTRA, E-UTRAN Evolved UTRAN, EVM Error vector magnitude, and FDD Frequency division duplex.

Still yet other terms include FFT Fast Fourier transform, FRC Fixed reference channel, FS1 Frame structure type 1, FS2 Frame structure type 2, GSM Global system for mobile communication, HARQ Hybrid automatic repeat request, HDL Hardware description language, HI HARQ indicator, HSDPA High speed downlink packet access, HSPA High speed packet access, HSUPA High speed uplink packet access, IFFT Inverse FFT, IOT Interoperability test, IP Internet protocol, LO Local oscillator, LTE Long term evolution, MAC Medium access control, MBMS Multimedia broadcast multicast service, MBSFN Multicast/broadcast over single-frequency network, MCH Multicast channel, MIMO Multiple input multiple output, MISO Multiple input single output, MME Mobility management entity, MOP Maximum output power, MPR Maximum power reduction, MU-MIMO Multiple user MIMO, NAS Non-access stratum, OBSAI Open base station architecture interface, OFDM Orthogonal frequency division multiplexing, OFDMA Orthogonal frequency division multiple access, PAPR Peak-to-average power ratio, PAR Peak-to-average ratio, PBCH Physical broadcast channel, P-CCPCH Primary common control physical channel, PCFICH Physical control format indicator channel, PCH Paging channel, PDCCH Physical downlink control channel, PDCP Packet data convergence protocol, PDSCH Physical downlink shared channel, PHICH Physical hybrid ARQ indicator channel, PHY Physical layer, PRACH Physical random access channel, PMCH Physical multicast channel, PMI Pre-coding matrix indicator, P-SCH Primary synchronization signal, PUCCH Physical uplink control channel, and PUSCH Physical uplink shared channel.

Other terms include QAM Quadrature amplitude modulation, QPSK Quadrature phase shift keying, RACH Random access channel, RAT Radio access technology, RB Resource block, RF Radio frequency, RFDE RF design environment, RLC Radio link control, RMC Reference measurement channel, RNC Radio network controller, RRC Radio resource control, RRM Radio resource management, RS Reference signal, RSCP Received signal code power, RSRP Reference signal received power, RSRQ Reference signal received quality, RSSI Received signal strength indicator, SAE System architecture evolution, SAP Service access point, SC-FDMA Single carrier frequency division multiple access, SFBC Space-frequency block coding, S-GW Serving gateway, SIMO Single input multiple output, SISO Single input single output, SNR Signal-to-noise ratio, SRS Sounding reference signal, S-SCH Secondary synchronization signal, SU-MIMO Single user MIMO, TDD Time division duplex, TDMA Time division multiple access, TR Technical report, TrCH Transport channel, TS Technical specification, TTA Telecommunications Technology Association, TTI Transmission time interval, UCI Uplink control indicator, UE User equipment, UL Uplink (subscriber to base station transmission), UL-SCH Uplink shared channel, UMB Ultra-mobile broadband, UMTS Universal mobile telecommunications system, UTRA Universal terrestrial radio access, UTRAN Universal terrestrial radio access network, VSA Vector signal analyzer, W-CDMA Wideband code division multiple access

It is noted that various aspects are described herein in connection with a terminal. A terminal can also be referred to as a system, a user device, a subscriber unit, subscriber station, mobile station, mobile device, remote station, remote terminal, access terminal, user terminal, user agent, or user equipment. A user device can be a cellular telephone, a cordless telephone, a Session Initiation Protocol (SIP) phone, a wireless local loop (WLL) station, a PDA, a handheld device having wireless connection capability, a module within a terminal, a card that can be attached to or integrated within a host device (e.g., a PCMCIA card) or other processing device connected to a wireless modem.

Moreover, aspects of the claimed subject matter may be implemented as a method, apparatus, or article of manufacture using standard programming and/or engineering techniques to produce software, firmware, hardware, or any combination thereof to control a computer or computing components to implement various aspects of the claimed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving voice mail or in accessing a network such as a cellular network. Of course, those skilled in the art will recognize many modifications may be made to this configuration without departing from the scope or spirit of what is described herein.

As used in this application, the terms “component,” “module,” “system,” “protocol,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for wireless communications, comprising:
employing a processor executing computer executable instructions stored on a computer readable storage medium to implement the following acts:
receiving measurement gap information;
receiving random access procedure information; and
scheduling a random access procedure based on the measurement gap information and the random access procedure information.

2. The method of claim 1, further comprising scheduling the random access procedure between measurement gaps.

3. The method of claim 2, the random access procedure includes at least one random access preamble.

4. The method of claim 2, the random access procedure includes at least one random access response.

5. The method of claim 2, the random access procedure includes at least one scheduled message transmission.

6. The method of claim 2, the random access procedure includes a portion of a transmission for contention resolution.

7. The method of claim 1, the random access procedure is associated with a random access channel (RACH) that is transmitted across a physical random access channel (PRACH).

8. The method of claim 7, further comprising defining a first time period that enables the beginning of the PRACH.

9. The method of claim 8, further comprising defining a second time period that begins about at the end of the first time period and provides a random access response window.

10. The method of claim 8, further comprising defining a third time period that begins about at the first time period, extends past the second time period, and ends about at a scheduled transmission window.

11. The method of claim 10, further comprising determining a timing displacement of one or more measurement gaps.

12. The method of claim 11, further comprising scheduling a PRACH transmission when a random access response window and a scheduled transmission window do not overlap with the one or more measurement gaps.

13. A communications apparatus, comprising:
a memory that retains instructions for determining measurement gap timing data, determining random access messages, and scheduling the random access messages in view of the message gap timing data; and
a processor that executes the instructions.

14. The apparatus of claim 13, further comprising scheduling the random access messages between measurement gaps.

15. The apparatus of claim 14, the random access messages include a random access preamble, a random access response, a scheduled transmission message, or a contention resolution message.

16. The apparatus of claim 13, further comprising generating a random access response window and a scheduled transmission window between measurement gaps.

17. The apparatus of claim 16, further comprising defining at least three timing parameters T1, T2, and T3 that determine the random access response window and the scheduled transmission window.

18. The apparatus of claim 17, further comprising a scheduler to configure T1, T2, or T3 timing parameters.

19. The apparatus of claim 18, the scheduler is associated with user equipment, a network component, or a base station.

20. A communications apparatus, comprising:
means for processing measurement gap information;
means for determining random access procedure information; and
means for scheduling random access messages based on the measurement gap information and the random access procedure information.

21. The apparatus of claim 20, the random access messages are scheduled between measurement gaps.

22. A computer-readable medium, comprising:
determining measurement gap information;
receiving random access procedure information; and
configuring random access messages based on the measurement gap information and the random access procedure information.

23. The computer-readable medium of claim 22, the random access messages are configured to occur between measurement gaps.

24. The computer-readable medium of claim 22, the random access messages are associated with a random access channel (RACH) and a physical random access channel (PRACH).

25. A processor that executes the following instructions:
receiving measurement gap timing information;
processing random access procedure information; and
configuring random access messages based on the measurement gap timing information and the random access procedure information.

26. The processor of claim 25, further comprising configuring the random access messages between measurement gaps.

27. A method for wireless communications, comprising:
employing a processor executing computer executable instructions stored on a computer readable storage medium to implement the following acts:
generating measurement gap information;
processing random access procedure information; and
configuring a random access procedure based on the measurement gap information and the random access procedure information.

28. The method of claim 27, further comprising scheduling the random access procedure between measurement gaps.

29. The method of claim 27, the random access procedure includes at least one random access preamble, at least one random access response, at least one scheduled message transmission, or a portion of a transmission for contention resolution.

30. The method of claim 27, the random access procedure is associated with a random access channel (RACH) that is transmitted across a physical random access channel (PRACH).

31. The method of claim 27, further comprising configuring a timing displacement of one or more measurement gaps.

32. A communications apparatus, comprising:
a memory that retains instructions for generating measurement gap timing data, processing random access messages, and configuring the random access messages in view of the message gap timing data; and
a processor that executes the instructions.

33. The apparatus of claim 32, further comprising configuring the random access messages between measurement gaps.

34. A communications apparatus, comprising:
means for generating measurement gap information;
means for generating random access procedure information; and
means for configuring random access messages based on the measurement gap information and the random access procedure information.

35. The apparatus of claim 34, the random access messages are scheduled between measurement gaps.

36. A computer-readable medium, comprising:
processing measurement gap information;
generating random access procedure information; and
generating random access messages based on the measurement gap information and the random access procedure information.

37. The computer-readable medium of claim 36, the random access messages are generated between measurement gaps.

38. A processor that executes the following instructions:
processing measurement gap timing information;
generating random access procedure information; and
determining random access messages based on the measurement gap timing information and the random access procedure information.

39. The processor of claim 38, further comprising configuring the random access messages between measurement gaps.
